(19) United States
(12) Patent Application Publication
(10) Pub. No.: US 2024/0168951 A1
(43) Pub. Date: May 23, 2024

(54) METHOD OF SEARCHING FOR DATA FOR MACHINE LEARNING TASKS

(71) Applicant: Roman Vladimirovich POSTNIKOV, Moscow (RU)

(72) Inventor: Roman Vladimirovich POSTNIKOV, Moscow (RU)

(21) Appl. No.: 18/282,635

(22) PCT Filed: Mar. 14, 2022
(86) PCT No.: PCT/RU2022/050078

§ 371 Date: Sep. 18, 2023

(30) Foreign Application Priority Data
Mar. 22, 2021 (RU) 2021107455

(51) Int. Cl. G06F 16/2455

(52) U.S. Cl. CPC G06F 16/2455

(57) ABSTRACT

A data search method generates a search request at the client's data node and sends the request and provision of request for the search request to the client's data node. The client's data set is specified during the search request generation that comprises objects and labels matching the objects. The search request is sent to the data node of at least one data owner. Upon receipt of the search request, the objects are characterized by a set of features that comprises at least one feature from the owner's data set, at least one function of dependence between the set of features and labels is identified, the value of at least one loss function for the function of dependence between the set of features and labels is calculated; and information comprising the calculated loss function value is used as a response to the search request.

The invention relates to the field of machine learning, particularly to methods for searching relevant data for machine learning tasks from a set of data available in paid or free access and stored on data nodes of various data owners.

As is known, one of the variants of machine learning is “supervised learning” during which a labeled end data set is specified that contains objects characterized by a set of features and corresponding to the label objects. It is assumed that a certain target dependence (functional or stochastic) exists between objects and labels and, accordingly, between the set of features that characterize the objects and the labels. In this case, the learning process essentially means finding a function of dependence between the set of features and labels according to a certain algorithm of machine learning based on a specified labeled end data set, where the “features” shall be understood as variable functions, and the “label” shall be understood as the function value. Moreover, to make the identified function practically applicable to complete certain tasks, for example, the tasks in classification or regression, it shall approximate the target dependence not only at a specified set of objects, but also at conventionally infinite multiplicity of objects characterized by the same set of features.

It is obvious that the degree of approximation of the obtained dependency function to the target one directly depends on the set of labeled data used for training. In this case, not only the number of “object-label” pairs (so called “examples”, or “use cases”) is important, but also by which set of features the objects are characterized. Moreover, both correlation between the features in the set and correlation between each individual feature from the set and label have essential impact on the quality of learning.

Thus, it is easy to notice that the task of searching and expansion of the set of features is the critical aspect of machine learning process. Currently, there are several services known in the field that help solve this problem, such as Dawex and Google Dataset Search.

Dawex is a data exchange platform that allows various organizations to distribute, receive, exchange, share, and monetize data, as well as manage the data ecosystem.

Google Dataset Search works similarly to the standard Google search service and provides the user with the ability to enter a natural language search query describing the desired data set, and in response, receive a list of data owners that are presumably relevant to the search query based on the textual description of the data, as well as links to the owners' websites. This service is chosen as a prototype for the present invention.

Thus, by using one of these services, a client can find the necessary data set and, after downloading it, apply it to machine learning tasks. It is obvious that the found data sets can be applied in different ways. For example, a labeled data set that the client already has can be expanded by adding new features that characterize the existing objects in it.

The disadvantages of both services mentioned above are represented by the fact that, in case a wanted data set after search is to be used for machine learning tasks, fundamentally, the client in the process of search cannot assess the degree of relevance of the found data sets to the task for completion of which that search was conducted. To understand the degree of how much this or another data set found, namely, how much influence these or other features from the data set found that were used to characterize objects from the client's labeled data set will have on the quality of the function of dependence searched in the process of machine learning will become possible for the client only after downloading such data set and appropriate application thereof. Additionally, it should be noted that free downloading of data may not be available as the data may only be accessible through paid access. In such cases, the client has no opportunity to fully evaluate the relevance of the found data to their task before purchasing.

Thus, in terms of machine learning, the aforementioned analogs and their provided mechanisms for searching datasets are ineffective as they do not allow for the evaluation of the relevance of search results to specific machine learning tasks. It should be noted that this disadvantage is not only due to the way the search response is provided, but also due to the way the search query is formed. The aforementioned analogs use semantic search type, where the search query is formulated by the client in natural language, which does not effectively characterize the machine learning task for which the searched dataset is intended to be used.

Therefore, the task of the present invention is to create a method of searching for data for machine learning tasks, the implementation of the main stages of which would ensure the achievement of the technical result, consisting in increasing the degree of relevance of search results for machine learning tasks, providing an assessment of the specified degree of relevance for each of the results, and as a result, simplifying and speeding up the search process as a whole.

The stated problem is solved by developing a method of searching for data for machine learning tasks, which includes forming a search query on the client's data node, sending it, and providing a response to the search query on the client's data node. When forming a search query, a set of client data is specified, containing objects and corresponding object labels. The search query is sent to the data node of at least one data owner. After receiving the search query, the objects are characterized by a set of features containing at least one feature from the data owner's data set. At least one dependency function between the set of features and labels is found, and the value of at least one loss function for the dependency function between the set of features and labels is calculated. The information containing the calculated value of the loss function is used as a response to the search query.

The claimed method, firstly, provides the possibility of specifying such information in the process of forming a search query that can accurately determine for which machine learning task it is necessary to find data sets. In essence, the search query represents a set of labeled data that is formed by the corresponding technical specialist on the client side, preparing data for machine learning. Such a set of labeled data is an integral part of the process of supervised machine learning, therefore, according to the claimed method, the formation of a search query does not require any additional actions on the client side. Secondly, using such information from the search query, the data owner's data node can take actions to assess how relevant the data on it is to the search query. To do this, locally at the data owner's data node, objects from the client's data set are characterized by features from the data set of the data owner and trained with a teacher, as indicated above, to find the dependence function between the set of features and labels. Next, in order to give a qualitative assessment of the found function, and therefore, the features from the data set of the data owner, the loss function value for the found dependence function is calculated. Therefore, the implementation of the above stages of the claimed method, in particular, how the search query is formed and in what form the response to it is provided, allows to increase the relevance of search results for machine learning tasks, while including the calculated value of the loss function for the dependence function between the set of features containing features from the data set of the data owner and labels, the client is provided with the opportunity to assess the indicated degree of relevance. Thus, the claimed method in general allows to simplify and speed up the process of searching for data for machine learning tasks.

An important aspect of this is that the evaluation of the relevance of the found data sets is carried out without the need to transfer the data owner's data to the client. Although, after selecting the necessary data set for its use, it will be necessary to transmit from the data owner's data node to the client node, the need for such transmission at the stage of search and selection is completely excluded.

It should be understood that the implementation of this method in full, namely—with the presence of multiple data nodes of data owners to which the search query is centrally distributed and processed, as well as the presence of various additional aspects of the claimed method, which will be described below, is preferably carried out using a search service and, accordingly, using at least one data node of the search service.

As for the algorithm used for machine learning on the data owner's data node, there are several preferred implementations of the present invention.

In one preferred implementation, at least one machine learning algorithm is set when forming a search query; the search query is sent and the response to the search query is provided directly or through at least one data node of the search service; and the dependency function between the set of features and labels is found by learning according to the specified algorithm.

In another preferred implementation, the search query is sent and the response to the search query is provided directly or through at least one data node of the search service, and before finding the dependency function between the set of features and labels, the data owner's data node determines the label type in the client's data set and selects at least one machine learning algorithm for a certain type of label, and the dependency function between the set of features and labels is found by learning according to the selected algorithm.

In yet another preferred implementation, the search query is sent and the response to the search query is provided through at least one data node of the search service, and before finding the dependency function between the set of features and labels, the search service's data node determines the label type in the client's data set and selects at least one machine learning algorithm for a certain type of label, and the dependency function between the set of features and labels is found by learning according to the selected algorithm.

In all of the above implementations of the present invention, it is preferred to select hyperparameters of the machine learning algorithm using at least one search method during the learning process.

It is evident that for practical implementation of the current method with a large number of data owners, it is impractical to send a search request to all available data providers without first assessing their potential to have relevant data to the search query. Therefore, it is preferable to use an data node of the search service as an intermediate link between the client and the data owner, and after receiving the search query, perform a preliminary selection of data owners who potentially may contain relevant data to the search query from the general list of data owners available to the search service.

Thus, in the preferred implementation option of the present invention, the search request is sent and the response to the search query is provided through at least one data node of the search service. Before forming the search request, at least one data node of the data owner registers metadata about the data set of the data owner on the data node of the search service. When forming the search query, metadata about the client's data set is registered on at least one data node of the search service. Before sending the search request to the data node of the data owner, the data node of the data owner is selected on the data node of the search service by comparing metadata about the client's data set and metadata about the data set of the data owner.

In the context of this application, the term “metadata” should be understood as broadly as possible, namely as any possible information about a client's dataset and/or data owner. Thus, metadata can be considered as features that characterize objects (e.g. “Temperature”, “Color”, “Number of visitors”, etc.), where the value of the features for specific objects is not meant, but rather the existence of a particular feature as a characteristic of objects. Moreover, it should be noted that objects in datasets can also contain identifiers—some “unique” features that allow to distinguish these objects from other objects, i.e. to identify them. Therefore, it is preferable that when registering metadata about the data owner's dataset and the client's dataset on the search service data node, identifiers of objects in the data owner's dataset and the client's dataset are determined, and the characterization of objects is carried out by finding matches of identifiers and their values in the data owner's dataset with identifiers and their values in the client's dataset, and assigning feature values from the data owner's dataset corresponding to each of the matching identifier values, to objects in the client's dataset characterized by matching identifier values, respectively. An identifier can be, for example, “Passport number”, “Bank account number”, “Geographic coordinates”, “Date/Time”, etc. Although identifiers themselves cannot positively influence the learning process, that is, improve the function of dependence between features and labels, due to their uniqueness, they allow to precisely match feature values from the data owner's datasets with objects from the client's datasets. This aspect is discussed in more detail in the implementation examples of the claimed method described below.

In addition, features containing information about the date and/or time, specifically the date and/or time the data was recorded in the dataset of the data owner and/or client, can also be considered metadata. Therefore, in a preferred implementation of the present invention, when registering metadata about the dataset of the data owner and/or metadata about the client dataset on the data node of the search service, time intervals for which the data in the dataset of the data owner and/or client dataset are available are determined.

It should be understood that there are various implementations of the claimed method in terms of interaction with the client. In a preferred implementation of the present invention, the formation, and/or sending, and/or provision of a response to a search query is performed using a user interface and/or an application programming interface (API). Thus, on the client side, interaction can be implemented, for example, through a website using certain interface elements (similar to traditional search services) or within an integrated development environment by connecting the appropriate libraries and calling the appropriate functions.

Regarding the content and format of the response to a search query, it should be understood that there are many possible implementations of the claimed method. In a preferred implementation of the present invention, the information used as a response to a search query includes a description of the data owner, and/or a link to the data owner's website, and/or a link to the application programming interface for accessing at least one dataset of the data owner.

Also, multiple embodiments of the present invention exist from the viewpoint of where and by which features the objects from the client's data set are characterized and, therefore, how a search request is generated and what is included in the response thereto.

Thus, in one of the preferable embodiments of the present invention, when forming a search query, objects are characterized by at least one feature from the client's dataset, and after receiving the search query, objects are characterized by a set of features containing at least one feature from the owner's dataset and at least one feature from the client's dataset. As mentioned above, the quality of training reflects not only the correlation between each individual feature from the dataset and the label, but also the correlation between the features in the dataset. Thus, in this implementation variant, during training on the data owner's data node, a function of dependence between the set of features and labels is found, where the set of features contains not only features from the data owner's dataset, but also features from the client's dataset. Therefore, this preferred implementation variant allows evaluating the relevance of the data owner's found data to the search query, taking into account the correlation between the features from the data owner's dataset and the features from the client's dataset.

In another preferable embodiment of the present invention, before forming a search query, objects are characterized by at least one feature from the client's dataset, at least one dependence function is found between the features from the client's dataset and the labels, and at least one loss function value is calculated for the dependence function between the features from the client's dataset and the labels. When forming a search query, the calculated loss function value is indicated for the dependence function between the features from the client's dataset and the labels, the loss function values for the dependence function between the features from the data owner's dataset, containing at least one feature from the data owner's dataset, and the labels are compared, and in response to the search query, information about at least one data owner is included, whose loss function value for the dependence function between the set of features containing at least one feature from the data owner's dataset and the labels is less than the loss function value for the dependence function between the features from the client's dataset and the labels. Thus, this implementation variant allows evaluating whether the features from the data owner's dataset provide an opportunity to obtain a more accurate dependence function (i.e. a dependence function that is more closely approximated to the target dependence than the dependence function found using features from the client's dataset), and to understand to what extent such a dependence function will be better. In addition, data owners whose datasets, despite containing machine learning relevant data, cannot provide the client with the opportunity to find a more accurate dependence function than the one already available to the client will be automatically excluded from the search query response.

In yet another preferable embodiment of the present invention, when forming a search query, objects are characterized by at least one feature from the client's data set. After receiving the search query, at least one dependency function between features from the client's data set and labels is found, and the value of at least one loss function is calculated for the dependency function between features from the client's data set and labels. The values of the loss function for the dependency function between features from the client's data set and labels and the dependency function between the set of features containing at least one feature from the owner's data set and labels are compared. In response to the search query, information about at least one data owner is included, whose loss function value for the dependency function between the set of features containing at least one feature from the owner's data set and labels is less than the loss function value for the dependency function between features from the client's data set and labels. Essentially, this implementation achieves the same result as the previous one, the only difference is which data node performs the machine learning to find the dependency function between the features from the client's data set and labels, and then calculates the loss function value for this dependency.

In general, it should be understood that multiple embodiments of the present invention are possible in relation which stages of the method are implemented on which data nodes. For example, the calculation of at least one loss function value can be performed by either the data owner data node or the search service data node.

It should also be noted that the claimed technical solution provides the possibility of using additional mechanisms to help the client find the most relevant search result faster. Thus, in the preferred implementation of the present invention, the information used as a response to the search query is sorted by the values of the corresponding loss functions. It should be understood that various known loss functions can be used as loss functions, such as quadratic, binary, and simple. In this case, information containing the values of several loss functions is preferably used as a response to the search query, and accordingly, the possibility of sorting by the values of each of the loss functions is provided.

As is known, certain functions called metrics are used to evaluate the quality of the dependent functions between features and labels found as a result of machine learning. A variety of metrics are widely used in machine learning tasks, for example, in classification tasks, “accuracy” (the proportion of correct “answers”), “precision” (the proportion of objects correctly classified by the classifier into a certain class, relative to the total number of objects classified into the given class), “recall” (the proportion of objects correctly classified by the classifier into a certain class, relative to all objects that actually belong to this class), “F-measure” (the harmonic mean value of “precision” and “recall”), etc. There are also metrics that characterize the stability of the values of the loss function over a certain time interval, and metrics that characterize the predictive power of a certain feature. Obviously, using the values of various metrics calculated from the dependent functions between features from data sets of data owners and labels, it is possible to evaluate the degree of relevance of the found data sets to the client's search query. Thus, in the preferred implementation of the present invention, after calculating the value of the loss function for the dependent function between the set of features and labels, at least one metric characterizing the stability of the values of the loss function over at least one time interval is calculated, and the calculated value of the metric characterizing the stability of the values of the loss function over at least one time interval is included in the information used as a response to the search query. In addition, in the preferred implementation, after finding the dependent function, at least one metric characterizing the predictive power of at least one feature from the data set of the data owner is calculated, and the calculated value of the metric characterizing the predictive power of at least one feature from the data set of the data owner is included in the information used as a response to the search query.

It should be understood that the implementation of the claimed method is preferably carried out by a corresponding system containing at least one client data node, at least one search service data node, and at least one data provider data node, all of which are connected through a computer network (local or internet). The client data node and/or the search service data node contain program instructions stored on a machine-readable storage medium of the respective data node. When executed by at least one processor of the client data node and/or the search service data node, these program instructions ensure the formation of a search query with an indication of the client's data set containing objects and corresponding labels, the sending of the search query to at least one data owner data node, the provision of a response to the search query on the client data node, and the data owner data node contains program instructions stored on a machine-readable storage medium of the data owner data node. When executed by at least one processor of the data owner data node, these program instructions ensure the specification of object characteristics through a feature set containing at least one feature from the data owner's data set, the identification of at least one dependency function between the feature set and the labels, and the calculation of at least one loss function value for the dependency function between the feature set and the labels. The response to the search query contains the calculated loss function value.

Preferably, the system is implemented in such a way as to provide the possibility of implementing all of the specified preferred implementation options of the claimed method.

In the context of this application, an data node should be understood as any stationary or mobile computing device, such as a server, personal computer, laptop, smartphone, tablet, etc., as well as a group of such devices combined into a single computing system. Access to such a system can be implemented both directly and through the use of a “thin” client, for example, through a web browser.

It should also be understood that interaction between data nodes can be implemented both directly and through various types of network equipment, as well as through other data nodes.

The specified preferred implementation options of the method according to the present invention are given as an example and do not limit the scope of claims in this application. The claimed method can be implemented in any other way, including characterized by the claimed set of essential features.

The claimed solution, implemented according to the most preferred implementation option, is implemented as follows.

First of all, a system is organized, containing at least one client data node, at least one search service data node, and data nodes of data owners, united by a computer network (local or internet).

Next, using data nodes of data owners, metadata about data sets of data owners is registered on the search service data node. At the same time, identifiers of objects in the data set of the data owner are determined.

Next, a search query is formed on the client data node, indicating the client's data set, containing objects and corresponding object labels, where the objects are characterized by features from the client's data set. At the same time, metadata about the client's data set is also registered on at least one search service data node, and identifiers of objects in the client's data set are determined.

After that, a search query is sent via a computational network through the data node of the search service. The data node of the search service then determines the type of label in the client's dataset and selects a machine learning algorithm for the specific label type. The data node of the search service also selects data owner data nodes by matching metadata about the client's dataset with metadata about the data owner's dataset (primarily choosing between data owners, not between data nodes of one data owner).

Next, the search query is directed to the selected data owner data nodes. After receiving the search query, each data owner data node finds at least one dependency function between features from the client's dataset and labels, calculates the value of at least one loss function for the dependency function between features from the client's dataset and labels, while finding the dependency function between features and labels through learning the previously selected algorithm, and in the learning process, selects hyperparameters of the machine learning algorithm using at least one search method. Next, objects are characterized by a set of features, containing at least one feature from the corresponding data owner's dataset. At the same time, object characterization is carried out by finding matches of identifiers and their values in the data owner's dataset with identifiers and their values in the client's dataset and binding the feature values from the data owner's dataset corresponding to each of the matching identifier values to objects from the client's dataset characterized by matching identifier values, respectively. Next, at least one dependency function is found between the specified set of features and labels, the value of at least one loss function is calculated for the dependency function between the set of features and labels, while finding the dependency function between the set of features and labels through learning the previously selected algorithm, and in the learning process, selecting hyperparameters of the machine learning algorithm using at least one search method. Next, the data owner data nodes compare the loss function values for the dependency function between features from the client's dataset and labels and the loss function for the dependency function between the set of features containing at least one feature from the data owner's dataset and labels. In addition, after finding the dependency function by the data owner data nodes, the predictive power metrics of each feature in the data owner's dataset are calculated.

Then, a response to the search query is provided on the client's data node, including information only about those data owners whose loss function value for the dependency function between the feature set containing at least one feature from their data sets and labels is less than the loss function value for the dependency function between the features from the client's data set and labels. The information used as a response to the search query includes a description of each data owner, a link to their website and/or a link to access their data set, their computed loss function value for the dependency function between the feature set containing features from their data set and labels, as well as the computed value of metrics characterizing the predictive power of each feature from their data set. Additionally, the information used as a response to the search query is sorted by the loss function values so that the data owners with the smallest loss function value are listed first. During the implementation process, the formation, sending, and provision of the response to the search query are carried out using a user interface.

Below are the explanatory examples of the embodiments of the method claimed with reference to specific practical machine learning tasks.

### EXAMPLE NO. 1—SEARCHING FOR DATA SETS FOR PREDICTING THE TURNOVER OF A SALES OUTLET

In this example, a client-retailer has a data set comprising objects (records describing the facts of sales of a specific goods), and labels corresponding to objects (number of goods items sold). Initially, the client also has some machine learning model (some function of dependence found between the set of features and labels) that predicts the goods turnover of a sales outlet. In this case, said prediction function of dependence was found as a result of machine learning during which the objects were characterized by the set of features from the client's data set that comprised the following features: price of goods (price variation history), sales outlet work schedule, availability of competitive goods on the sales outlets' shelves, date when the record was made, sales outlet address (including ZIP code), etc. Also, the value of the loss function for the function of dependence between the features from the client's data set and labels was calculated. As a loss function, root mean squared logarithmic error (RMSLE) was calculated.

The goal is to find datasets containing features that are highly correlated with the labels, thus allowing the client to find a new dependence function that provides a more accurate forecasting result.

To do this, a client forms a search request using a system that implements the method claimed by specifying their data set comprising objects that correspond to the label objects, characterizing the objects by features at the same time. Thus, a search request is essentially a set of labeled data that is generated by a relevant technician on the client's side during preparation of data for machine learning.

In this example, the search query was sent and the response was provided through the data node of the search service. When forming the search query, the client's data node registered metadata about the client's dataset and identified object identifiers on the search service's data node. Then, the data nodes of the data owners were selected on the search service's data node by comparing the metadata of the client's dataset (in particular, identifiers) with the corresponding metadata of the data owners' datasets, which had been previously registered. In the aforementioned client dataset, ZIP codes indicating geographic areas where retail stores are located and the date of the record were defined as identifiers. Then, the data nodes of the data owners in whose datasets the same identifier (ZIP code) existed were selected. The search query was then sent through the search service's data node to the selected data nodes of the data owners.

In this example, one of the selected data owners was a weather data service, whose data node had an archive dataset containing features characterizing weather conditions (temperature, humidity, precipitation, etc.) linked to the same identifier (ZIP code), as well as indicating the corresponding date.

After receiving a search query, the data node characterized objects through a set of features that included features from both the owner's and client's data sets. Object characterization was done by finding matches between the ZIP codes and dates in the owner's data set with those in the client's data set, and linking feature values from the owner's data set that corresponded to each of the matching identifiers to objects in the client's data set that were characterized by the matching identifier values. In other words, the data set contained in the search query was supplemented with features from the owner's data set. Thus, the resulting labeled data set included objects characterized by the following features: product price (price change history), schedule of store operations, presence of other competitive products on store shelves, date, store address (including ZIP code), temperature, humidity, precipitation, where each object characterized by specific feature values corresponded to a label indicating the number of units sold.

Next, data owner data nodes (including the weather data service mentioned above) identified dependency functions between the obtained feature set containing features from both the owner's and client's data sets, and the labels, and computed the RMSLE loss function values for the identified dependency functions.

Then, the client data node provided a response to the search query, which included a description of each data owner, a link to their website, and a link to access their data set, as well as the computed value of the RMSLE loss function for the identified dependency function between the feature set containing features from their data set and the client's data set, and the labels.

This example can clearly demonstrate the disadvantages of semantic search used in the technical solution taken as a prototype, and accordingly, the advantages of the method for searching datasets claimed in this application. It should be noted that the client may not even suspect what kind of data may ultimately be relevant to his task and, accordingly, may not know what information to specify in the semantic search query. For example, weather data, which at first glance have nothing to do with predicting sales, can actually significantly increase the accuracy of the dependency function if the products themselves are related to weather conditions in which they are usually used by customers. Such products may include raincoats, ice cream, etc. Therefore, for such products, the dataset found as a result of using the claimed method with features characterizing weather conditions will have a high degree of correlation with the labels from the client's dataset and thus allow finding a dependency function that more accurately predicts sales, which will be reflected in the value of the RMSLE loss function calculated for this dependency function.

Thus, having received a response to the search query and comparing the value of the RMSLE loss function for the dependency function that the client initially had (meaning the dependency function between the features from the client's dataset and the labels) and the RMSLE loss function for the dependency function between the set of features containing features from the owner's dataset and the client's dataset, and the labels, the client can make sure that the dataset found by the owner of the data, which is the weather data service, is relevant to the client's machine learning task. Then the client can purchase the dataset found from the data owner if access to it is restricted or immediately download it if it is available in free access.

### EXAMPLE NO. 2—FINDING DATASETS FOR PREDICTING THE NUMBER OF VISITORS TO A SHOPPING CENTER

In this example, the client had a certain labeled dataset before them for predicting the number of visitors, obtained from marketing research. The client's dataset was labeled with records of the number of visitors. Before forming the search query, the objects were characterized by a set of features, including data on the number of cars in shopping center parking lots obtained by recognizing satellite images updated daily, data on the number of products sold, as well as the date and coordinates of the parking lots taken from the image descriptions.

It should be noted that, as in this example, it is not always possible to clearly understand what exactly is the “object” in the labeled dataset. In any case, an “object” should be understood as something described through an available set of feature values corresponding to a specific label. In other words, if you imagine the labeled dataset as a table where features are listed in columns, and labels are listed in the last column, then each row containing a set of specific feature values (without the last column) will essentially be an “object”, and the last column will contain the label value corresponding to a specific object.

Obviously, the client's dataset is not sufficient for finding a dependency function that would allow predicting the number of visitors with a high degree of accuracy, partly due to the lack of information on the number of cars in parking lots for each day. Thus, it was necessary to find datasets containing features that would be highly correlated with labels and thus allow finding a new dependency function that would provide a more accurate prediction result.

The implementation of the claimed method in this example, particularly the stages of formation, sending, and providing a response to a search query, as well as additional stages, are largely analogous to the previous example described above and therefore are described less in detail in the considered example.

Geographic coordinates and date served as identifiers. As a result of the search, the data owner was found, who had a dataset containing information on the number of devices registered in Wi-Fi networks on a daily basis with a reference to geographic coordinates. After receiving the search query, the data node characterized the objects by means of a set of features containing features from the data set of the data owner and features from the client's data set. Thus, the obtained labeled dataset characterized the objects with the following features: the number of cars in shopping center parking lots, data on the number of sold goods, date, parking coordinates and the number of devices registered in Wi-Fi networks. Next, the data node of this data owner found the dependency function between the obtained set of features, containing features from the data set of the data owner and features from the client's data set, and labels, and calculated the loss function value for the found dependency function.

Upon receiving a response to the search query, the client could compare the loss function value for the dependency function found using the dataset containing information about the number of devices registered in Wi-Fi networks with the loss function values from other data owners, ensure the high relevance of such a dataset to the machine learning task, and decide on the feasibility of its use.

Thus, the present invention represents a method of searching for data for machine learning tasks, implementation of the main stages of which ensures the achievement of the technical result, consisting in increasing the relevance of search results for machine learning tasks, providing an assessment of the indicated degree of relevance for each of the results and, as a consequence, simplifying and accelerating the search process as a whole.

It should be understood that the claimed method of searching for data for machine learning tasks, as defined in the accompanying formula of the invention, is not necessarily limited to specific features and implementation options described above. On the contrary, specific features and implementation options described above are disclosed as examples implementing the formula, and other equivalent features may be covered by the formula of the present invention.

1. A method of data search for machine learning tasks has been developed that comprises generation of a search request at the client's data node, sending thereof and provision of request for the search request to the client's data node, wherein
the client's data set is specified during the search request generation that comprises objects and labels matching the objects;
the search request is sent to the data node of at least one data owner;
upon receipt of the search request, the objects are characterized by a set of features that comprises at least one feature from the data owner's data set, at least one function of dependence between the set of features and labels is identified, the value of at least one loss function for the function of dependence between the set of features and labels is calculated;
upon receipt of the search request, at least one function of dependence between the features from the client's data set and labels is found, the value of at least one loss function for the function of dependence between the features from the client's data set and labels is calculated;
comparison of the values of the loss function for the function of dependence between the features from the client's data set and labels, and the loss function for the function of dependence between the set of features comprising at least one feature from the owner's data set and labels is carried out by the data nodes of the data owners.
a response to the search request is provided for the client's data node wherein information only on those data owners is included the value of the data loss function of which for the function of dependence between the features comprising at least one feature from the data set of the data owner and labels is less than the value of the loss function for the function of dependence between the features from the client's data set and labels.

2. The method according to claim 1, wherein
at least one machine learning algorithm is set during a search request generation;
search request sending and provision of response to the search request are carried out directly or through at least one data node of the search service;
and the function of dependence between the set of features and labels is identified by way of learning according to the set algorithm.

3. The method according to claim 1, wherein
search request sending and provision of response to the search request are carried out directly or through at least one data node of the search service;
prior to identification of the function of dependence between the set of features and labels by the data owner's data node, the type of label in the client's data set is identified and selection of at least one machine learning algorithm for a certain label type is performed;
and the function of dependence between the set of features and labels is identified by way of learning according to the selected algorithm.

4. The method according to claim 1, wherein
search request sending and provision of response to the search request are carried out through at least one data node of the search service;
prior to identification of the function of dependence between the set of features and labels by the search service data node, the type of label in the client's data set is identified and selection of at least one machine learning algorithm for a certain label type is performed,
and the function of dependence between the set of features and labels is identified by way of learning according to the selected algorithm.

5. The method according to claim 2, wherein hyper parameters of the machine learning algorithm are selected in the learning process using at least one exhaustive search method.

6. The method according to claim 1, wherein
search request sending and provision of response to the search request are carried out through at least one data node of the search service;
registration of metadata on the data sets of the data owner at the search service data node is carried out using at least one data node of the data owner;
registration of metadata on the client's data set at at least one search service data node is carried out during generation of the search request,
and selection of the data owner's data node at the search service data node is carried out prior to sending the search request to the data owner's data node by comparison of the metadata on the client's data set and metadata on the data owner's data set.

7. The method according to claim 6, wherein
identifiers of objects in the data owner's and client's data sets are determined during registration of the metadata on the data owner's and client's data sets at the search service data node,
and object characterization is carried out by finding identifiers and values thereof in the set of data of a data owner matching the identifiers and values thereof in the set of the client's data, and by binding the values of the features from the data set of the data owner corresponding to each matching identifier value to the object from the client's data set characterized by matched identifier values, respectively.

8. The method according to claim 6, wherein time intervals during which the data in the data owner's and/or client's data sets are available are determined during registration of metadata on the data owner's and/or client's data sets at the search service data node.

9. The method according to claim 1, wherein
data owner description and/or link to the data owner's site, and/or link to an application programming interface are included in the information used as a response to a search request to gain access to at least one data set of the data owner.

10. The method according to claim 1, wherein
objects are characterized by at least one feature from the client's data set during generation of a search request;
after receipt of the search request, the objects are characterized by a set of features comprising at least one feature from the data owner's data set and by at least one feature from the client's data set.

11. The method according to claim 1, wherein
objects are characterized by at least one feature from the client's data set prior to generation of a search request, and at least one function of dependence is detected between the features from the client's data set and labels, and the value of at least one loss function is calculated for the function of dependence between the features from the client's data set and labels;
the value of the loss function calculated for the function of dependence between the features from the client's data set and labels is specified;
comparison of the values of the loss function for the function of dependence between the features from the client's data set and labels, and the loss function for the function of dependence between the set of features comprising at least one feature from the owner's data set and labels is carried out by the data nodes of the data owners.
a response to the search request is provided for the client's data node wherein information only on those data owners is included the value of the data loss function of which for the function of dependence between the features comprising at least one feature from the data set of the data owner and labels is less than the value of the loss function for the function of dependence between the features from the client's data set and labels.

12. The method according claim 1, wherein calculation of the value of at least one loss function is carried out by the data owner's data node, or by the search service node.

13. The method according to claim 1, wherein information used as a response to a search request is sorted by values of the appropriate loss functions.

14. The method according to claim 1, wherein generation and/or sending, and/or provision of response to a search request are carried out using the user interface and/or application programming interface.

15. The method according to claim 1, wherein
after calculation of the value of the loss function for the function of dependence between a set of features and labels, at least one metric value is calculated that characterizes the stability of values of the loss function during at least one time interval;
and the calculated metric value that characterizes the stability of the loss function values during at least one time interval is included in the information used as a response to a search request.

16. The method according to claim 1, wherein
after finding the function of dependence, the value of at least one metric is calculated that characterizes the predictive performance of at least one feature from the data owner's data set,
and the calculated metric value that characterizes the predictive performance of at least one feature from the data owner's data set is included in the information used as a response to a search request.
